(19) United States
(12) Patent Application Publication
(10) Pub. No.: US 2015/0337806 A1
(43) Pub. Date: Nov. 26, 2015

(54) METHOD, SYSTEM AND CONTROLLER FOR CONTROLLING A WIND TURBINE

(71) Applicant: KK Wind Solutions A/S, Ikast (DK)

(72) Inventors: Chris Damgaard, Herning (DK); Claus Damgaard, Herning (DK)

(21) Appl. No.: 14/758,578

(22) PCT Filed: Feb. 7, 2013
(86) PCT No.: PCT/DK2013/050033

§ 371 Date: Jun. 30, 2015

(51) Int. Cl. F03D 7/04; F03D 7/02; G05B 15/02; F03D 1/00

(52) U.S. Cl. CPC F03D 7/047; F03D 1/00; F03D 7/0264; G05B 15/02

(57) ABSTRACT

The invention relates to a method of controlling a wind turbine (WT) by means of a wind turbine control system (WTCS) comprising a first controller (C1) and a second controller (C2), said controlling of said wind turbine (WT) comprising handling a first set of control functionalities (CF1-CFx) and a second set of control functionalities (CCF1-CCFx), wherein said first set of control functionalities (CF1-CFx) are non-critical control functionalities, wherein said second set of control functionalities (CCF1-CCFx) comprises one or more critical control functionalities (CCF1-CCFx) which are critical for the operation of said wind turbine (WT), wherein said first controller (C1) handles said first set of control functionalities (CF1-CFx), wherein said second controller (C2) is a safety controller controlling said wind turbine during emergency shutdown of said wind turbine (WT) by means of said critical control functionalities (CCF1-CCFx), and wherein said second controller (C2) furthermore controls one or more of said critical control functionalities to provide an output to control said wind turbine (WT) when the wind turbine (WT) is in a power production mode. The invention furthermore relates to a system, a controller and a wind turbine.

The present invention relates in a first aspect to a method of controlling a wind turbine, in a second aspect to a system for controlling a wind turbine and in a third aspect a controller for controlling a wind turbine and in a fourth aspect a wind turbine.

### BACKGROUND ART

During the recent years, the complexity of software and hardware of wind turbines has increased. For example, the amount of data collected from wind turbines has increased significantly to comprise thousands of data parameters from each wind turbine. Also, the control of the pitching of the wind turbine blades has become more sophisticated to e.g. reduce the forces that components of the wind turbine are subjected to, to increase efficiency of the wind turbine and/or the like. Additionally, the data communication systems in the wind turbines have been improved and the control of the wind turbine in relation to the grid is more advanced. Such improvements among others entail an efficient wind turbine with improved durability and safety. However, it also entails a complex control which needs to be stable and reliable.

EP 2 080 903 discloses a wind turbine control system with two control units coupled to each other. One of the control units comprises a set of critical control functions for the operation of the wind turbine, and the other control unit is a secondary control unit comprising non-critical control functions. However, this solution is still subjected to drawbacks in the form of e.g. limitations that among others makes the system expensive and complex.

It is among other an object of the present invention to reduce wind turbine costs and/or to provide a stable and reliable wind turbine control system.

### BRIEF DESCRIPTION OF THE INVENTION

The invention relates to a method of controlling a wind turbine by means of a wind turbine control system comprising a first controller and a second controller, said controlling of said wind turbine comprising handling a first set of control functionalities and a second set of control functionalities,

wherein said first set of control functionalities are non-critical control functionalities,

wherein said second set of control functionalities comprises one or more critical control functionalities which are critical for the operation of said wind turbine,

wherein said first controller handles said first set of control functionalities,

wherein said second controller is a safety controller controlling said wind turbine during emergency shutdown of said wind turbine by means of said critical control functionalities, and

wherein said second controller furthermore controls one or more of said critical control functionalities to provide an output to control said wind turbine when the wind turbine is in a power production mode.

This facilitates that a reliable control during both normal operation and during emergency shutdown is provided, e.g. in that the second controller preferably operates at a higher degree of safety compared to the second controller. The second controller will normally, since it is a safety controller, demand a higher degree of approval by e.g. a third party such as an approving or certifying authority before being allowed to be put into operation as a safety controller. Further the second controller has to comply with strict requirements after updating or amending of the hardware and/or the software of the second controller, compared to the requirements the first controller has to comply with. Hence updates relating to the first controller may be performed without or at least with limited demands of approval by an approving authority.

Moreover, further advantages in relation to e.g. improved cost efficiency may be achieved.

Non-critical control functionalities may comprise logging of data, control and/or monitoring of lubrication systems, control system monitoring, generator monitoring, control and/or monitoring of one or more hydraulic systems of the wind turbine etc., monitoring of environmental data such as ambient temperature and/or humidity, monitoring of weather parameters such as ice detection systems for detecting ice on the wind turbine blades, heating systems for melting ice on blades and/or the like.

In general it is understood that the non-critical control functionalities preferably comprises functionalities that are not critical to the safety and/or mechanical loads of the wind turbine. If for example a lubrication system of the wind turbine gets out of order or at least trigger an alarm, the wind turbine may either continue to operate or may be put into a normal shut down procedure of the wind turbine which is different from the emergency shutdown procedure. Another example of a non-critical control function may be monitoring and/or action on the basis of registered temperature in panels inside the wind turbine which enclose one or more heat generating equipment such as electronic components in the form of circuit boards, electric power supplies and/or the like.

It is understood that the critical control functionalities in aspects may be divided into control functionalities for providing an output to control arrangements of the wind turbine, and critical monitoring functionalities for monitoring critical inputs that are needed to control the wind turbine in a safe way. This is described in more details later on. Both such critical control functionalities are preferably handled by the second controller.

Preferably, all the control functionalities handled by the second controller are critical, but in aspects, one or more control functionalities handled by the second controller may be non-critical control functionalities.

For the purpose of the present document the “power production mode” is to be understood where the wind turbine is in a “normal” operation mode, and not in a mode to be shut down by emergency shutdown. The “power production mode” or “normal” operation mode is to be understood as when a wind turbine starts up to produce power, when it is in operation to produce power, when it shuts down due to e.g. low wind speeds and/or non-critical faults detected in the wind turbine and/or the like.

A non-critical fault may e.g. comprise a vibration alarm that identifies that a bearing or a toothed wheel should be repaired to avoid further damage to a bearing or the generator, and or the like. Such non-critical faults may allow a normal shutdown procedure of the wind turbine which may take into consideration e.g. the wind turbine's acting in relation to the utility grid, to reduce critical forces acting on the wind turbine during shut down to a minimum and/or the like.

A further example of a fault that may be considered non-critical may be that e.g. a cooling system of the wind turbine reports an error that allows the cooling system to continue to operate at least for a shorter period before shutting down, and hence allowing a normal shutdown procedure. The control of the cooling system may however in aspects be considered as a critical control function.

An emergency shutdown of the wind turbine on the other hand may most likely cause or at least allow significantly higher stress values to the wind turbine structure and its components due to e.g. a safe and the same time rapid shutdown of the wind turbine compared to a normal shutdown. If for example a measurement arrangement for measuring the wind speed and/or direction suddenly breaks down, the wind turbine may not act properly and the wind turbine may hence be subjected to critical forces due to a change in wind direction or wind speed. Such forces may cause severe mechanical loads on the wind turbine structure and components, and result in that main components of the wind turbine such as e.g. the gear or the generator is broken or need replacement. Additionally or alternatively, it may cause severe mechanical loads on the blades and/or tower to an extent that would break or severely damage the tower or blade(s). Such critical faults may hence be critical to human safety and/or the structure of the wind turbine. Hence, the second controller may enter an emergency shutdown mode where the second controller in a safe way shuts down the wind turbine, preferably based on e.g. vibration/oscillation measurements of the wind turbine tower and/or wind turbine blades, and performs a blade pitching according thereto. During emergency shutdown, the wind turbine's acting in relation to the utility grid may at least partly be neglected, higher forces acting on wind turbine components and the wind turbine structure may be allowed during emergency shutdown than during normal shutdown and/or the like.

The first controller and the second controller may be individual separate control unit arranged in each their individual casing, and may e.g. in embodiments be supplied with power from different power supplies. Alternatively however, the first and second controller may be arranged in a common casing in the wind turbine and may in further embodiments share hardware such as computing processing units, data storage(s) circuit boards, input/output arrangements and/or the like.

Due to the present invention, costs to wind turbines may be reduced in that the safety level during both normal operation and during emergency shutdown may be guaranteed so that the amount of material used for e.g. the tower and other components may be reduced because it becomes possible to control closer to the mechanical design limits.

Additionally, dividing the functionalities between the controllers facilitates that the need for acceptance of the second controller from a certifying authority may be reduced compared to if all functionalities are handled by the second controller. The reason for this is that an amendment of a control functionality of the second controller may trigger the need for a new acceptance of the second controller from the certifying authority in that it is a safety controller.

In aspects of the invention, said second set of control functionalities are critical to control the mechanical loads of said wind turbine.

For example, the control of the pitching of the wind turbine blades may to a large extent be critical to the safety of the wind turbine in relation to mechanical loads and human safety. If for example the blades due to e.g. a measurement error or a broken wind speed sensor suddenly starts to pitch further into the wind, this may be critical to the wind turbine in that it may influent on the mechanical loads acting on the wind turbine tower, the wind turbine blades, the generator and/or several other components of the wind turbine even to an extent so that the components and/or the whole wind turbine itself is broken. It is noted that blade pitching in general may be used for controlling the forces acting on the wind turbine.

Another example may be monitoring and/or control of tower oscillations and/or blade oscillations. If the tower gets into oscillations, e.g. in an oscillation range that lies within a resonance frequency, this may severely affect the safety of the wind turbine and/or the mechanical loads acting on the wind turbine. So such a monitoring of the wind turbine and/or control of the wind turbine to prohibit critical tower and/or blade oscillations may in aspects be considered as critical control functionalities.

Further examples of a critical control function may be power speed control, the yawing of the nacelle to keep it in a correct position in relation to the wind direction.

If the wind direction changes and the nacelle is not yawed accordingly, damaging forces may act on the wind turbine.

This may e.g. improve the safety of the control of the wind turbine when the wind turbine is in a power production mode as well as to assure a safe emergency shutdown.

In preferred aspects of the invention, said second controller operates at a higher safety level than said first controller.

This may e.g. be advantageous in relation to prevent emergency breakdown of the wind turbine in that the wind turbine due to the safety controller operating at a higher standardized level during both normal operation and during emergency shutdown. So the different safety levels may e.g. advantageously facilitate that the second set of control functionalities are handled by the second controller at a higher standardized safety level during normal operation of the wind turbine than the first set of control functionalities handled by the first controller. At the same time, due to the reduced demands to the operation of the first controller, it may be easier to perform updates to the software and/or hardware of the first controller in that it would not be necessary to design the first controller to comply with certain safety standards.

The safety controller may e.g. ensure functional safety i.e. ensuring that equipment is operating correctly in response to its input. To achieve such functional safety, the safety controller may be adapted to fulfill the requirements in e.g. IEC EN 61508 “Functional Safety of Electrical/Electronic/Programmable Electronic Safety-related Systems (E/E/PE, or E/E/PES)”. Further relevant safety standards may be IEC 61062 and ISO EN 13849 (based on IEC EN 61508). Natural, other safety standards may be relevant in certain situations. The functional safety standard may have a significant impact on the hardware and software design. The functional standard may take care of the whole product life cycle from idea to product but also maintenance and to the product phase out. The standard is strict in regards to e.g. documentation, analysis, test, verification etc. to make sure that the product can obtain a high safety level.

In advantageous aspects of the invention, said second controller may be a redundant controller.

The feature of having a redundant controller operating said wind turbine during both normal operation and during emergency shutdown e.g. increases the safety and reliability of the wind turbine during both normal operation and during emergency shutdown.

The safety level may be identified by estimating the probability of dangerously failure of the second controller per hour. The safety controller would preferably be designed to produce significantly fewer failures per hour than the first controller.

By the term “redundant” is to be understood that certain hardware components and/or software applications which may be critical to allow the second controller to operate are duplicated to increase the reliability of the system.

Due to the reduced security demands of the first controller, the first controller may be a controller that does not comprise redundant hardware and/or software.

In advantageous aspects of the invention, said second controller comprises a data input arrangement receiving one or more data inputs, data processing means processing data from said one or more data inputs, and a data output arrangement providing data to one or more data outputs from said second controller based on said processing of said one or more data inputs, and said data processing means of said second controller comprises at least two processing arrangements each processing input representing the same data according to an identical set of rules, and a verifying arrangement selecting an output from at least one of said processing arrangements to form the basis for the data on output at said data output arrangement.

In aspects, the input representing the same input may be received from different data sources as explained below. In other aspects, the same data source may be used as input for two or more of the data processing arrangements.

The verifying arrangement may comprise a voter for selecting an output between outputs from a plurality of processing arrangements, it may comprise a fault detection arrangement for detecting faults in the output from the processing arrangements by comparing the outputs with each other and/or a predefined set of verification parameters stored in or accessed by the processing arrangements.

The utilization of a verifying arrangement and processing arrangements processing the same data facilitates a more reliable second controller.

In aspects of the invention, said second controller may process data from at least two data inputs which data represents the same information, and wherein the information is obtained from different data sources.

Data input which represents the same information may e.g. comprise information of the rotation speed of the generator rotor of the wind turbine. This may be represented both by a first source in the form of a meter that measures the rotation speed by means of e.g. an optical meter transmitting electromagnetic radiation towards the rotor and receives a feedback based on this, and a second source in the form e.g. a meter measuring the rotation speed of the input shaft of the gear in the wind turbine. By proper calculation of the second source by knowing the setup of the wind turbine and especially the gear, it may be possible to estimate the rotation speed of the generator. It is understood that a plurality of other data/information may be represented and/or calculated by means of different sources.

The above may result in a more fail safe system in that different data processors are used for processing the same data, and hence a failure in one of the sources may easily be detected by means of e.g. a voting arrangement in a redundant safety controller.

Further receiving the same information from different sources also increase safety of the control. Hence, the first source may represent input data/information to a first processing arrangement of the second controller and the second source may represent input data to a second processing arrangement of the second controller and hence, the processing arrangements processes the same data inputs (e.g. generator speed) which is further obtained from different data sources.

In preferred, advantageous aspects of the invention, said critical control functionalities comprises controlling the pitching of wind turbine blades of said wind turbine.

The pitching of wind turbine may be considered as a critical control function in that they the pitching may have a substantial impact on the mechanical loads acting on components of the wind turbine. By having the pitching of the blades controlled by functionalities of the second controller, a more reliable operation during both normal operation and during emergency shutdown may be achieved.

In advantageous aspects of the invention, said second controller may operate in accordance with one or more reference parameters, and wherein one or more software applications are configured for processing data inputs in accordance with said reference parameters so as to provide data output from said second controller.

Thus, the reference parameters may help to determine the operation mode of the second control unit. The reference parameters may determine a set of rules for determining the output of the second controller. For example, a reference parameter may determine a pitching ramp and/or curve defining how the wind turbine blades should pitch during an emergency shutdown.

The second controller may for example in aspects of the invention adjust the pitching of the wind turbine blades in accordance with or at least based on tower and/or blade oscillation measurements, which may be data input to the second controller in aspects of the invention, during emergency shutdown to prevent the wind turbine blades striking the tower due to tower bending and/or blade oscillations.

In advantageous aspects of the invention, the said second controller may shift from a first operation mode to an emergency shutdown mode if said wind turbine is to be shut down due to an emergency situation.

This may e.g. provide a cost efficient solution in that the same hardware and even in some situations at least some of the same software may be utilized during both normal “production” operation of the wind turbine and during emergency shutdown.

The shift may be performed based on one or more trigger criteria such as erroneous and/or absent data inputs, etc., exceeded predefined limits etc.

An emergency situation may be defined as a situation where there is a risk of damaging the wind turbine or persons near the wind turbine.

Advantageously, said shift may in aspects of the invention comprise shifting between different software control applications configured for handling the same functionality.

An example may be shifting between different pitching applications dependent on the operation mode. A first predefined pitching application in the form of a software application may operate in accordance with a first predefined set of rules and/or reference parameters. When entering emergency shutdown, the second controller may then shift to a second pitching application in the form of another software application operating in accordance with another predefined set of rules and/or reference parameters. So the second controller may hence comprise a first software application for normal pitching during (normal) power production mode, and another software application for use during emergency shutdown.

This may e.g. be relevant in relation to assuring a safe emergency shutdown.

In aspects of the invention, the said shift may comprise replacing the content of one or more reference parameters and/or utilizing a set of dedicated emergency reference parameters.

A reference parameter may be a set point such as a minimum or maximum pitch angle or speed or a range that the wind turbine should comply with by controlling e.g. pitch systems of the wind turbine, torque control system of the wind turbine, rotor and/or generator speed control systems of the wind turbine.

Hence, if the second controller suddenly shifts to operate in the emergency shutdown mode, a fast and advantageous shift may be achieved by such a replacement/utilization.

A further advantage of this is that the software to be used during emergency shutdown of the second controller may be used during “normal” operation of the wind turbine too. Hence, due to the high safety level during emergency shutdown, the wind turbine would be more reliable in the first normal operation mode too due to the utilization of the same piece of software where only reference parameters are amended or changed between to two modes of operation.

A reference parameter may e.g. define a set-points, limits, ranges, etc.

In further aspects of the invention, said shift comprises shifting to an emergency pitch mode configured for pitching one or more of said wind turbine blades so as to shut down said wind turbine, and wherein said second controller provides one or more pitch outputs determined by means of said emergency pitch mode to one or more pitch arrangements of said wind turbine.

The shift may e.g. comprise a replacement of the contentment of one or more reference parameters, operating in accordance with a set of emergency parameters such as e.g. a predefined pitch profile to be used during emergency shutdown and/or the like. The outputs may be provided to the pitch arrangements directly and/or to a pitch controller external to the second controller.

In aspects of the invention, pitching by means of said second controller may be performed according to one or more data inputs from one or more measurement arrangements during said emergency shutdown.

This may e.g. be performed so that the pitching of the blade(s) may be adjusted one or several times from the start of the emergency shutdown until the wind turbine has been shut down, e.g. based on measured tower oscillations during the emergency shutdown, measured blade oscillations during the emergency shutdown, measured blade root torque during the emergency shutdown and/or the like, e.g. to counteract for tower oscillations over a predefined value, blade oscillations over a predefined value, a torque over a predefined value and/or the like.

For example, during normal operation of the wind turbine, the tower may be deflected in the downwind direction under the influence of the wind. As an emergency shutdown mode is initiated, the blades may be pitched out of the wind so as to remove thrust from the rotor, and this induces that the tower moves in the upwind direction. When the tower has reached the extreme upwind direction, the tower starts to move back in the downwind direction. This may result in that the tower may oscillate significantly. Additionally, the pitching of the blades may result in the blades oscillating. As a result of these tower and/or blade oscillations, the blades may e.g. strike the wind turbine tower and cause severe damage to the wind turbine. However, by regulating e.g. the pitching of the blades during emergency shutdown based on measurements from for example vibration sensors arranged to measure tower and/or blade oscillations, such damages can be avoided. So the blades may be continuously pitched in both directions during emergency shutdown to reduce tower oscillations, blade oscillations, blade root torque, main shaft torque and/or the like.

Additionally, since this pitching facility is implemented in the second controller which operates under a high degree of safety compared to the first controller, a more reliable pitching during both normal operation of the wind turbine and during emergency shutdown is achieved.

The pitching profile may in an aspect of the invention be at least partly defined by one or more reference parameters.

In aspects of the invention, said shift may comprise shifting to an emergency torque scenario for reducing a torque in said wind turbine, and wherein said second controller provides a torque adjustment output determined by means of said emergency torque scenario according to one or more data inputs from one or more measurement arrangements during said emergency shutdown.

For example, a rapid pitching of a blade during emergency shutdown may cause a large torque acting on the blade root and/or the tower. Hence, by adjusting e.g. the pitching of a blade during emergency shutdown based on e.g. a reference parameter defining the maximum allowable torque, a fast and at the same time safe shutdown may be facilitated.

For example, the maximum allowable torque (or another reference parameter) may be of a higher value or tolerance than the one allowed when the wind turbine is not to be exposed to an emergency shutdown. This may e.g. allow a higher degree of pitching and/or faster pitching of a blade than when the wind turbine is not to be exposed to an emergency shutdown

In preferred aspects of the invention, said second controller comprises one or more processing arrangements, and wherein one or more of said one or more processing arrangements are configured for handing said critical control functionalities during both normal operation and during emergency shutdown of said wind turbine.

In relation to reducing the costs to the wind turbine control system, it is advantageous to utilize the same hardware for handling the critical control functionalities during both normal operation of the wind turbine and during emergency shutdown of the wind turbines. Furthermore, it may facilitate a less complex hardware solution and provide a system which is easy to maintain and perform service on.

A processing arrangement may in aspects of the invention comprise one or more central processing units (CPU), data storages such as Random Access Memories (RAM), circuit board(s) and/or the like.

Said second controller may in aspects of the invention comprise software code for processing input data so as to provide data outputs from said second controller, wherein said software code is utilized for handling said critical control function during both normal operation to provide a power output, and during emergency shutdown of said wind turbine.

As an example, the same software code for pitching a blade WTB may be used by the second controller when the wind turbine is in normal operation and when it is in emergency shutdown. However reference parameters for determining allowed torque, vibration, pitch speed etc. may be amended or exchanged, some input data may be neglected during emergency shutdown and/or the like. So the critical control functions may comprise an algorithm which is used during both normal operation and during emergency shutdown, but input for use in the algorithm may be changed if the second controller shifts to another scenario.

This may e.g. provide the advantage that the need for approval of the second controller may be reduced, and a more reliable safety controller may be achieved.

In aspects of the invention, said second controller may be reset to operate the wind turbine in a power production mode after an emergency shutdown.

This may be achieved by exchanging/amending reference parameters, amend/reintroduce data inputs for the operation of the wind turbine and/or the like.

In preferred aspects of the invention, said second controller provides one or more outputs based on one or more of said one or more critical control functionalities.

These outputs may be transmitted to different application of the wind turbine such as e.g. converter, generator, pitch arrangements, cooling facilities and/or the like.

In aspects of the invention, said critical control functionalities may be selected from a list consisting of:
pitching of wind turbine blades,
control of power output and/or rotation speed of the wind turbine rotor and/or generator of the wind turbine,
yaw control to rotate the nacelle),
thrust force control such as thrust force control of wind turbine tower and/or wind turbine blades, and
generator torque control.

In advantageous aspects of the invention, at least one of said critical control functionalities handled by said second controller may comprise critical monitoring functionalities.

In aspects, at least one of such monitoring functionalities is selected from a list consisting of:
thrust force monitoring,
shaft acceleration monitoring,
monitoring of tower oscillations,
monitoring of blade oscillations,
monitoring of main shaft oscillations,
rotor/generator speed monitoring,
rotor/generator acceleration monitoring,
nacelle acceleration monitoring,
pitch position tracking monitoring,
yaw misalignment to monitor that the pitch position follow a pitch reference,
pitch incoherence monitoring to monitor that the difference of the pitch position between the blades does not exceed predefined limits,
wind speed monitoring,
blade root torque monitoring,
tower torque monitoring, and
monitoring of wind speed and/or wind direction.

The critical monitoring functionalities may be defined by that they are critical to a proper operation of the wind turbine, and if e.g. they are omitted or absent, the wind turbine should enter emergency shutdown to safely and/or rapidly shut down the wind turbine. In aspects the second controller may monitor the critical monitoring functionalities, and if they are absent or erroneous, the second controller enters the emergency shutdown mode.

In aspects of the invention, said critical monitoring functionalities may be utilized for providing said one or more outputs.

In a second aspect of the invention, the invention relates to a system for controlling a wind turbine, said system comprising a first controller and a second controller, said controlling of said wind turbine comprising handling a first set of control functionalities and a second set of control functionalities,

wherein said first set of control functionalities are non-critical control functionalities,

wherein said second set of control functionalities comprises one or more critical control functionalities which are critical for the operation of said wind turbine,

wherein said first controller is configured for handing said first set of control functionalities,

wherein said second controller is a safety controller configured for controlling said wind turbine during emergency shutdown of said wind turbine by means of said critical control functionalities, and

wherein said second controller furthermore is configured for controlling one or more of said critical control functionalities to provide an output to control said wind turbine when the wind turbine is in a power production mode.

In aspects of the second aspect of the invention, said system may be configured for controlling said wind turbine according to the method of one or more of claims 1-22.

In a third aspect of the invention, the invention relates to a controller, for controlling a wind turbine, said controlling comprising handing one or more critical control functionalities which are critical for the operation of said wind turbine,

wherein said controller is a safety controller configured for controlling said wind turbine during emergency shutdown of said wind turbine by means of said critical control functionalities, and

wherein said second controller furthermore is configured for controlling one or more of said critical control functionalities to provide an output to control said wind turbine when the wind turbine is in a power production mode.

In aspects of said third aspect of the invention, said controller is configured for controlling said wind turbine according to the method of one or more of the claims 1-22.

In a fourth aspect, the invention relates to a wind turbine comprising a wind turbine control system according to any of claims 23-24.

It is understood that e.g. one or several of the advantages obtained by the aspects of the method applies with the above mentioned aspect(s) relating to the controller, the system and/or the wind turbine.

### FIGURES

The invention will be explained in further detail below with reference to the figures of which:

FIG. 1: illustrates an electrical power generating system in form of a wind turbine according to embodiments of the invention,

FIG. 2: illustrates a wind turbine control system according to embodiments of the invention,

FIG. 3: illustrates a flow chart disclosing an advantageous operation of a controller according to embodiments of the invention,

FIG. 4: illustrates a controller comprising two or more redundant processing arrangements according to embodiments of the invention,

FIG. 5: illustrates further embodiments of the invention,

FIGS. 6 and 7: illustrates advantageous embodiments of the invention relating to blade pitching,

FIG. 8: illustrates advantageous embodiments relating to shifting from a normal operation into emergency shutdown mode,

FIG. 9: illustrates advantageous embodiments relating to receiving and handling measurements, and

FIG. 10: illustrates a flow chart disclosing a further advantageous operation of a controller according to embodiments of the invention.

### DETAILED DESCRIPTION OF THE INVENTION

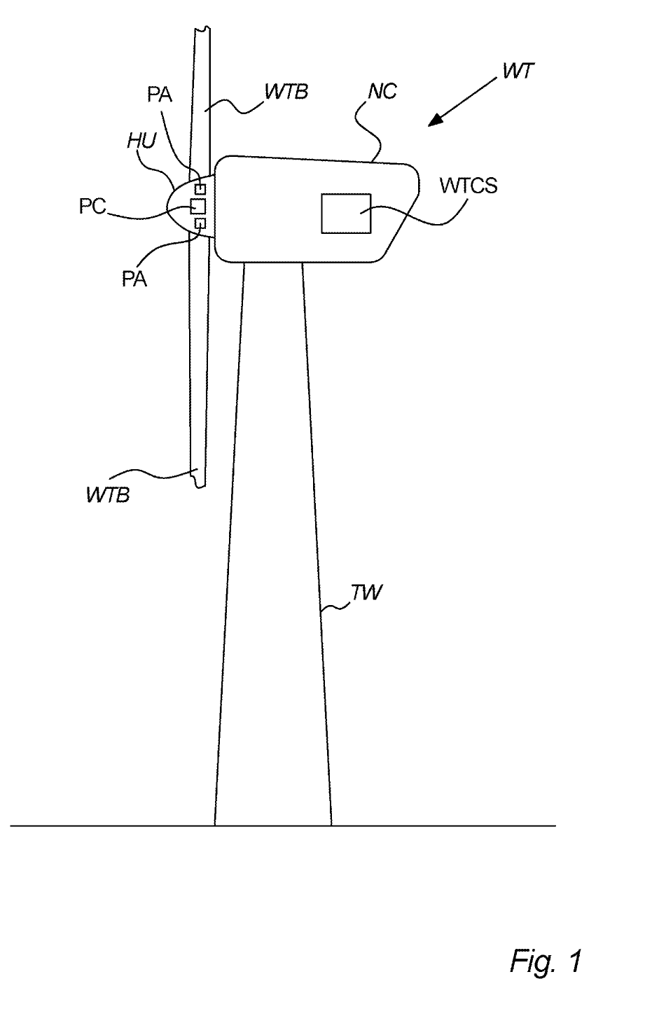

FIG. 1 illustrates an electrical power generating system in form of a wind turbine WT according to an embodiment of the invention. The wind turbine WT comprises a plurality of wind turbine components of which some are illustrated in FIG. 1 such as tower TW, a nacelle NC, a hub HU and two or more wind turbine blades WTB. The blades WTB of the wind turbine WT are rotatable mounted on the hub HU, together with which they are referred to as the rotor. The rotation of a blade WTB along its longitudinal axial is referred to as pitching and may be controlled by a pitch arrangement PA and pitch controller PC.

The wind turbine WT moreover comprises a power generator, in some embodiments a gear arrangement, and converter arrangement. These wind turbine components as well as others are however not illustrated. The rotor is connected to the gear arrangement and the gear arrangement is connected to the generator which converts the kinetic energy obtained from the wind into electric energy. In other embodiments, it may be a wind turbine comprising a direct drive arrangement without a gear arrangement. The generator is connected to the converter to adapt the electric energy from the generator to the utility grid e.g. by a conversion from alternating current (AC) to direct current (DC) and then to alternating current (AC), by means of a matrix converter performing an AC/AC conversion and/or the like. The alternating current is then feed to the utility grid.

The wind turbine furthermore comprises a wind turbine control system WTCS configured for controlling the wind turbine WT.

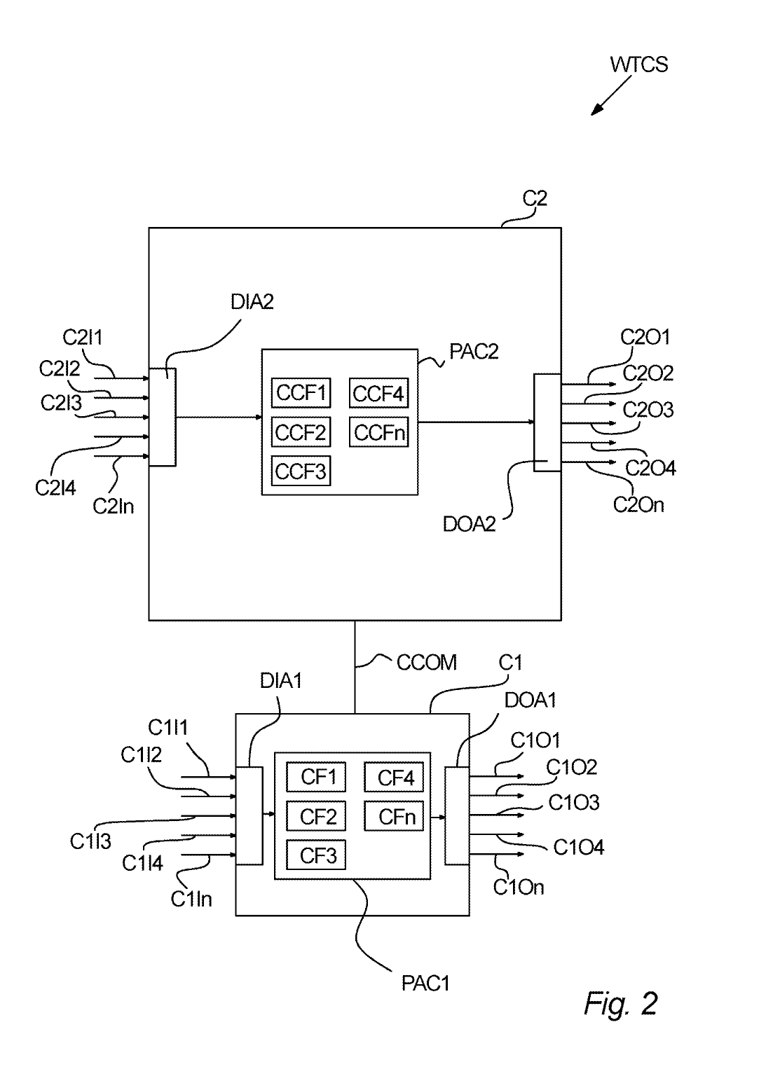

FIG. 2 illustrates a wind turbine control system WTCS according to embodiments of the invention for controlling a wind turbine WT. The system WTCS comprises a first control unit C1 and a second control unit C2. The first controller C1 comprises a data processing arrangement PAC1 which is configured for controlling/handling a first set of control functionalities CF1, CF2, CF3, CF4, CFn that are non-critical control functionalities for the control of the wind turbine WT.

The second controller C2 comprises a data processing arrangement PAC2 which is configured for controlling/handling a second set of control functionalities comprising critical control functionalities CCF1, CCF2, CCF3, CCF4, CCFn that are critical for the operation of said wind turbine WT. Their preferred functionalities relate to human safety and functionalities that may be critical to control the mechanical loads acting on the wind turbine. The control functionalities are described in more details later on.

It is understood that the critical control functionalities may be divided into control functionalities for providing an output to control arrangements of the wind turbine WT, and critical monitoring functionalities for monitoring critical inputs that are needed to control the wind turbine in a safe way. Both such critical control functionalities are preferably handled by the second controller C2.

In embodiments, the second controller C2 comprises a software code configured for processing input data so as to e.g. provide the data outputs C2O1-C2On from the second controller C2. This software code is utilized in the critical control functions CCF1-CCFn during both normal operation to e.g. have the wind turbine providing a power output to the utility grid, and during emergency shutdown of the wind turbine WT, e.g. by utilizing different reference parameters, input data and/or the like. Hence the control function as such (whether it is critical or not) may be a software application or code facilitating control or monitoring of wind turbine components, data logging, etc. the term normal operation should hence be understood as when the wind turbine is in a power production mode and not in emergency shutdown.

It is understood that inputs to the second controller C2 and/or outputs from the second controller in embodiments may be input data for the first controller C1.

The first controller C1 receives data input C1I1-C1In which is received by means of a data input arrangement DIA1 of the first controller C1. The data input C1I1-C1In is then provided to the data processing arrangement PAC1. The data processing arrangement PAC1 receives the data input (or one or more derivatives thereof) which is used by one or more of the control functionalities CF1, CF2, CF3, CF4, CFn to e.g. provide one or more data outputs C1O1-C1On. These data outputs or control commands are then used to control one or more applications of the wind turbine WT or functionalities of wind turbine components. The data outputs C1O1-C1On are communicated to a relevant receiver by means of a data output arrangement DOA1 of the controller C1. Also, the data inputs C1I1-C1In may in embodiments be used for data logging, and may hence in some embodiments not result in an output from the first controller C1 but may instead be stored in a data storage (not illustrated) of the first controller.

The second controller C2 receives data input C2I1-C2In which is received by means of a data input arrangement DIA2 of the second controller. The data input C2I1-C2In is then provided to the data processing arrangement PAC2. The data processing arrangement PAC2 receives the data input (or one or more derivatives thereof) which is used by one or more critical control functionalities CCF1, CCF2, CCF3, CCF4, CCFn to provide one or more data outputs C2O1-C2On by means of an output arrangement DOA2 of the controller C2 to control one or more applications or wind turbine components.

The second controller C2 is a safety controller which is configured to control the wind turbine WT during emergency shutdown by means of one or more critical control functionalities CCF1-CCFn. Additionally, critical control functionalities CCF1-CCFn for the control of the wind turbine WT are controlled by the second controller C2 when the wind turbine WT is in a power production mode to provide an output of electric power to e.g. the utility grid (not illustrated). Also, the second controller C2 may be used for controlling the wind turbine in relation to normal start-up and shutdown of the wind turbine WT. So the second controller C2 controls critical control functionalities CCF1-CCFn of the wind turbine WT both during normal operation and during special situations such as emergency shutdown of the wind turbine WT.

Hence the second controller C2 is arranged to shift operation mode from normal operation of the wind turbine WT to e.g. an emergency shutdown mode. The emergency shutdown of the wind turbine WT may be initiated by e.g. a fault, an event automatically triggering a mechanically controlled safety arrangement e.g. based on monitoring critical control functionalities, and/or critical monitoring functionalities, my manually triggering an emergency stop and/or the like.

The first controller C1 and the second controller C2 are preferably separate individual control units arranged in each their casing, but in other embodiments, the controllers C1, C2 may be incorporated in the same casing but comprise separate individual processing arrangements, data storages, data input arrangements, power supplies and/or the like. In some embodiments however, one processing arrangement may however be arranged for handling at least some of the control functionalities of both the first controller C1 and the second controller C2.

Additionally, the first controller C1 and the second controller C2 may be connected by a data connection CCOM allowing the controllers C1, C2 to exchange data. This data communication path may facilitate that input data to one of the controllers C1, C2 may be used in the other controller too, it may facilitate that the second controller C2 can transmit control signals to the first controller C1 so as to shut down one or more of the non-critical control functionalities during emergency shutdown and/or the like. The latter may e.g. comprise that the second controller C2 instructs the first controller to shut down at least some of the functionalities controlled by the first controller C1. For example shut down the cooling system, to finish storing of logged data, and/or the like.

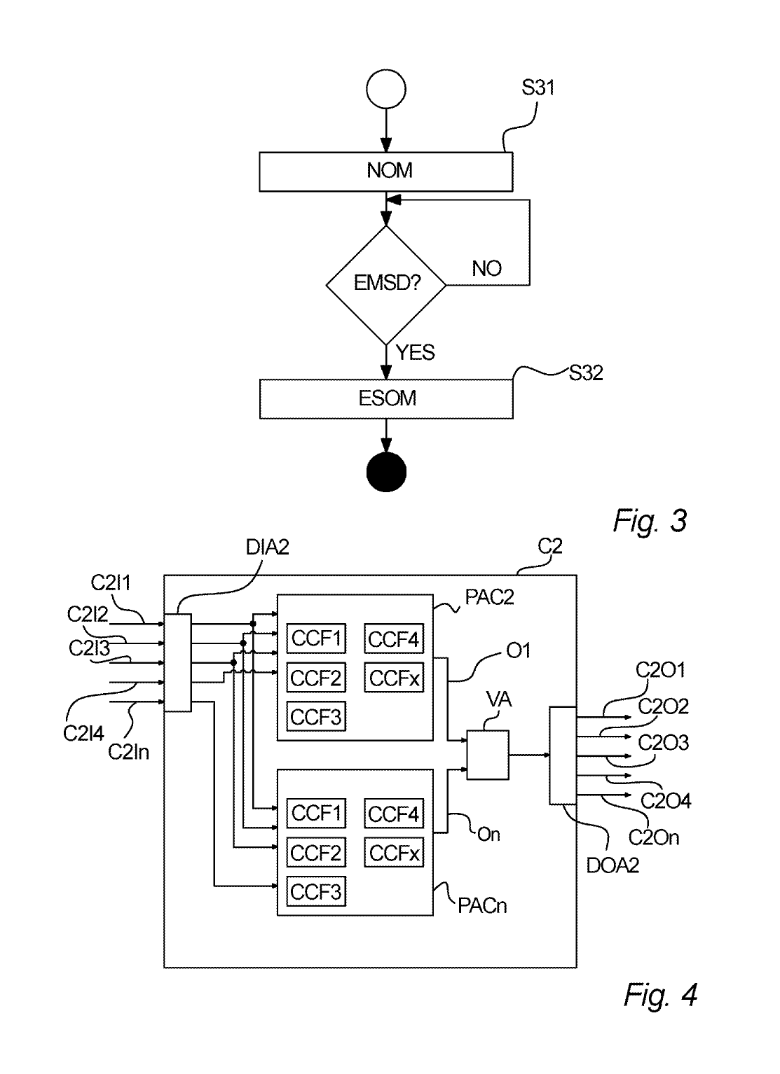

FIG. 3 illustrates a flow chart disclosing an advantageous operation of the second controller C2 according to embodiments of the invention.

In Step 31, the second control unit C2 operates in a normal power production mode NOM so as to e.g. start up the wind turbine WT, operate the wind turbine WT to produce electric power, facilitate a normal shut down of the wind turbine WT e.g. in case of too low or too high wind speed, due to maintenance of the wind turbine WT and/or due to other criteria, and/or the like. The second controller C2 additionally monitors if the wind turbine WT should be shut down due to for example an emergency resulting in an emergency stop being activated, due to an error in a monitored critical monitoring functionality, due to a suddenly occurred fault triggered and/or the like. In case an emergency shutdown should be initiated, the second controller switches into an emergency shutdown operation mode ESOM as illustrated in step S32.

In the emergency shutdown mode ESOM, the second controller C2 may e.g. directly operate pitching arrangements PA of the wind turbine WT to pitch the wind turbine blades WTB, it may transmit control signals to a pitch controller PC of the wind turbine WT external to the second controller C2 and/or the like.

Also, the second controller C2 may transmit control signals to yaw the nacelle, it may shut down electronic components of the wind turbine WT, transmit alert signals, transmit one or more control signals to a converter arrangement of the wind turbine WT and/or other main components of the wind turbine and/or the like.

In general it is understood that the critical control functions are control functions that are critical to assure safety and to assure that components of the wind turbine are not damaged due to too large forces acting on them. For example pitching of the blades has a significant impact on the mechanical loads acting on the blades, the generator, the wind turbine tower and/or the like, so this is considered as a critical control functionality. Additionally, certain monitoring of components may be considered as critical, e.g. tower vibration monitoring, in that if not knowing the extent of tower vibrations, the control system cannot take such vibrations into consideration during control, and hence the tower may oscillate to an extent where the blades strikes the tower or other parts of the wind turbine gets damaged due to the oscillation. Additionally, wind speed (and/or direction) monitoring may be considered as critical in that these parameters may be considered as important to assure safety and avoid mechanical damage to the wind turbine.

It is understood that switching from the normal power production mode NOM to the emergency shutdown mode ESOM may be based on certain criteria. For example it may be based on a monitoring of e.g. the safety loop, the rotational speed of the main shaft, oscillations of the tower and/or wind turbine blades, a converter monitoring, a vibration monitoring of the gearbox of the wind turbine, and/or any other monitoring that is considered critical to assure safety and/or to appropriately control the mechanical loads acting on the wind turbine during shutdown.

An example may be that a vibration sensor arrangement (suddenly) is registering that the vibration of the gearbox increases significantly so that they exceeds an alert threshold e.g. due to a broken toothed wheel of the gearbox. This may trigger an emergency shutdown where the second control unit C2 enters the emergency shutdown mode ESOM so as to achieve a rapid and/or safe shut down the wind turbine WT.

Another example may be that an increase in the torque acting on a lower part of a wind turbine blade (at the root end of the blade) is registered to exceed a predefined threshold which is set up to assure that the blade and/or the hub or the blade bearing is/are damaged in a way so that it may cause danger to nearby people and/or a vital mechanical damage to the wind turbine that would be expensive to remedy. This may likewise trigger an emergency shutdown where the second control unit C2 enters the emergency shutdown mode ESOM so as to safely shut down the wind turbine WT.

Another example may be that the safety loop is broken e.g. by a person opening a “door” to the nacelle, pushing an emergency stop or the like.

It is understood that any suitable criteria and/or algorithms in embodiments may be utilized by the second controller C2 so as to facilitate an acceptable degree of emergency shutdown surveillance.

The second controller C2 may be designed to comply with certain standards relating to functional safety requirements. Such standards may e.g. be IEC EN 61508 “Functional Safety of Electrical/Electronic/Programmable Electronic Safety-related Systems (E/E/PE, or E/E/PES)”. Also IEC 61062 and ISO EN 13849 may be relevant. In preferred embodiments, the critical control functionalities CCF1, CCF2, CCF3, CCF4, CCFn handled by the second controller C2 are designed to comply with such standards, and additionally, the hardware configuration of the second controller C2 is preferably designed comply with such standards.

This is described in more details in relation to FIG. 4. In advantageous embodiments of the invention, the second controller C2 is a redundant controller which comprises one or more duplications or substantially similar components or functions so as to increase the reliability of the second controller C2 to provide a more fail-safe controller.

As illustrated in FIG. 4, the second controller C2 may comprise two or more redundant processing arrangements PAC2-PACn, for example three, four or five processing arrangements PAC2-PACn.

Each of the processing arrangements handles and processes the same critical control functionalities CCF1, CCF2, CCF3, CCF4, CCFn based on the same input or an input which represent the same parameter, and should ideally provide the same output O1-On to a verifying arrangement VA.

If for example the second controller C2 comprises three data processing arrangements PAC2-PACn, and if a first and a second of these provide substantially the same output while the third control arrangement provides an output that deviates significantly from the other two control arrangements, the output from the third processing arrangement may be outvoted so that the output from the first or the second control arrangement is used as output at the data output arrangement.

In other embodiments, the second controller C2 may comprise two redundant processing arrangements PAC2-PACn, and a verifying arrangement VA may be configured to process the output O1-On from these two redundant processing arrangements PAC2-PACn so as to determine if the output is at least substantially identical. If not, the second control unit C2 may enter the emergency shutdown mode ESOM so as to rapidly shut down the wind turbine WT. In this embodiment, the safety controller C2 comprises two or more processing arrangements PAC2-PACn, and if the output from these deviates from each other, the safety controller initiates emergency shutdown.

It should be mentioned that using a voter VA to determining validity of output form processor arrangement may be one way for the second controller C2 to determine whether to enter (emergency) shutdown mode or not, and it is understood that any other suitable type of verifying arrangement may be relevant for processing outputs O1,On from the processing arrangements.

It is furthermore understood that the second controller C2 may comprise one or more data storages for storing software code related to the critical control functions, reference parameters as disclosed in more details e.g. later on in this document, FIG. 4 furthermore illustrates an embodiment where different input data representing the same parameter are used as input for each their processing arrangement PAC1, PACn. In FIG. 4, the fourth input data C2I4 is used as input for the first processing arrangement PAC2, while the input data C2In is used as input for a second processing arrangement PAC2. The fourth input data C2I4 and the input data C2In represents the same data but is obtained from different data sources. For example, the fourth input data C2I4 may represent an input from a meter, for example a sensor device for measuring generator speed while input data C2In represents input data which by proper processing can be adapted to also represent the generator speed. Alternatively two identical meters measuring identical information of a wind turbine component may be use used one as input C2I4 and the other as input C2In. C2I1, C2I2 and C2I3 are in the present example used as input for both of the data processing arrangements PAC2, PACn.

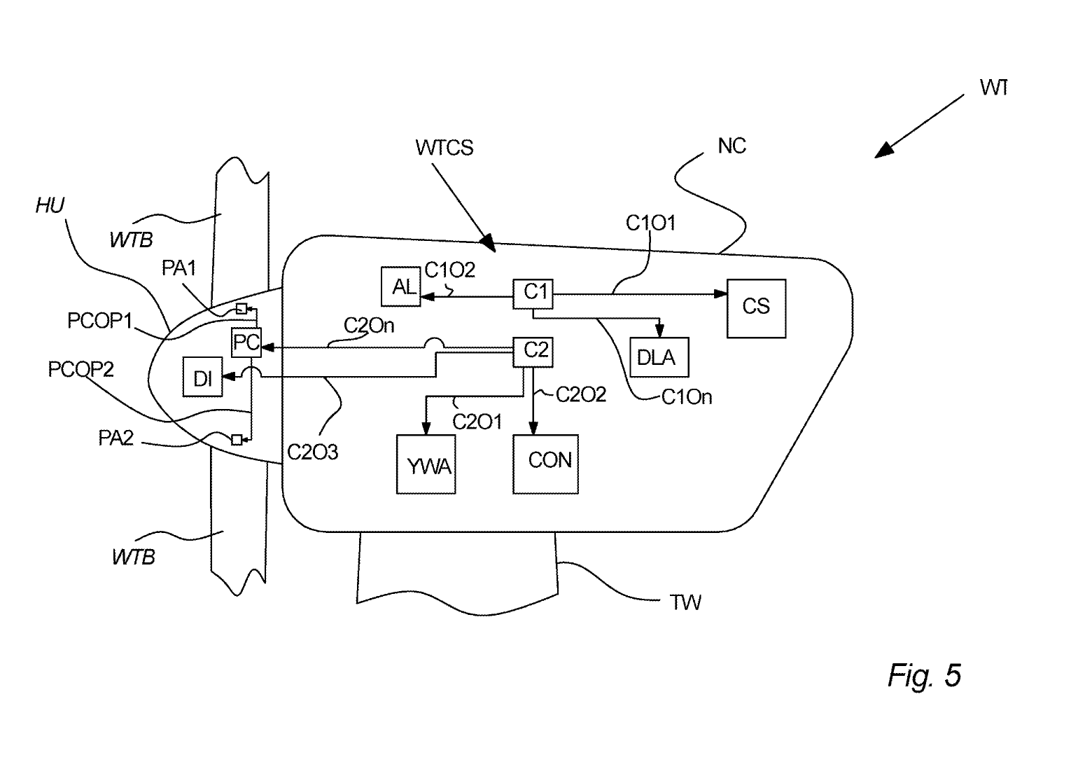

FIG. 5 illustrates an embodiment of the invention relating to one example of a division of control functionalities in the wind turbine control system WTCS between the first and second control units C1, C2. The first controller C1 and the safety controller/second controller C2 transmit control signals to different components, applications and/or arrangements of the wind turbine WT. The first controller C1 transmits control signals C1O1 to a cooling system CS so as to control cooling of e.g. electrical control systems of the wind turbine WT, mechanical components, generator components, and/or the like. This control may comprise a start and stop of the cooling system, control the amount of cooling in a cooling capacity range (e.g. 0-100% where 0 correspond to no cooling and 100% correspond to 100% cooling capacity), control which components/arrangements to be cooled and/or the like.

The first controller C1 additionally may control aviation light AL so as to warn nearby airplanes or helicopters that a high structure in the form of the wind turbine is near. If the wind turbine is arranged in a group of wind turbines comprising a plurality of wind turbines, the aviation light of the individual wind turbine may be considered as a non-critical control function and be handled by the first controller. The reason for this may be that the risk of all aviation light on all the wind turbines failing simultaneously is vanishingly small. However, if the wind turbine is arranged alone without other wind turbines nearby, the aviation light may be considered as critical to the safety and hence be controlled by the second controller. The reason for this is that if the aviation light in such a scenario breaks, there are no means present for warning airplanes or helicopters of the high structure nearby.

It is generally understood that other control functionalities such as e.g. temperature control of nacelle in the same way may be divided between the controllers C1, C2 dependent on the individual environment that the wind turbine is arranged in.

Furthermore, the first controller C1 may transmit control signals C1On to a data logging arrangement DLA which handles data logging in relation to logging of e.g. measured and/or estimated/derived data from sensors, fault registrations, alerts and/or other relevant data logging. In embodiments of the invention, the second controller C2 may also transmit logging data to be logged by the data logging arrangement DLA, but the control of the data logging and/or the transmission of logged data and/or access control to the logged data may be handled by the first controller C1.

In other embodiments, the data to be logged from the second controller C2 may be logged in another/further data logging arrangement which is not illustrated, and which would be considered as independent on the control of the data logging arrangement DLA, and the data logging arrangement DLA itself.

The second controller C2 may transmit control signals C201 to a yaw arrangement YWA to enable a rotation of the nacelle NC in relation to the wind turbine tower TW around a substantially vertical axis. This is preferably facilitated by the second controller C2 during both “normal” operation of the wind turbine WT and during emergency shutdown of the wind turbine WT if necessary to facilitate a safe emergency shutdown of the wind turbine WT.

Additionally, the second controller C2 may transmit control signals C202 to the converter CON of the wind turbine WT so as to e.g. provide proper handling of the power output of the wind turbine WT during emergency shutdown and/or during “normal” operation of the wind turbine WT when the wind turbine WT is not subjected to an emergency shutdown. So the second controller C2 may facilitate at least partly control of the converter CON of the wind turbine WT during both “normal” operation of the wind turbine WT and during emergency shutdown of the wind turbine WT if necessary to facilitate a safe emergency shutdown of the wind turbine.

It should be mentioned that e.g. the converter CON and pitch arrangement PA may be controlled by dedicated sub controllers but that the second controller C2 both during normal operation and during emergency shutdown may overrule the sub controllers or at least force the sub controllers to follow a certain control strategy.

Moreover, the second controller C2 may control a de-icing arrangement DI which take care of de-icing of the blades WTB of the wind turbine, e.g. by means of control signals C203 from the first controller C1 to the de-icing arrangement DI. The De-icing arrangement may be critical in an environment where ice may occur on the blades to an extent that the aerodynamic profile of the blades is altered during operation so that the mechanical loads on the blades changes significantly. The control of the de-icing may comprise a start and stop of the de-icing arrangement DI, control the amount of de-icing in a deicing capacity range (e.g. 0-100% where 0 correspond to no heating/de-icing and 100% correspond to 100% heating/de-icing capacity), and/or the like.

In a preferred embodiment, the second controller C2 transmits control signals C2On to control the pitching of the blades WTB of the wind turbine WT during both “normal” operation of the wind turbine WT and during emergency shutdown of the wind turbine WT if necessary to facilitate a safe emergency shutdown of the wind turbine WT. This may be facilitated in different ways according to embodiments of the invention.

FIG. 5 additionally illustrates an embodiment where the second controller C2 transmits control signals to a pitch controller PC, and the pitch controller PC transmits signals to one or more pitch arrangements PA1, PA2 of the wind turbine WT so as to pitch the blades WTB based on the control signals from the second controller C2. So the application of the second controller C2 which processes data to transmit the control signals to a pitch controller PC considered as a critical control functionality CCFn as explained above. In the embodiment of FIG. 5, the pitch controller PC is external to the second controller C2.

A pitch arrangement PA1-PAn may comprise an actuator such as for example a hydraulic linear actuator, one or more electric motors for pitching the blade(s). Hence, a pitch arrangement PA comprises control means to enable the pitching of the blades WTB based on a pitch control output PCOP1, PCOP2 from the pitch controller PC. Preferably, the wind turbine WT comprises a pitch arrangement PA1, PA2 for each wind turbine blade WTB of the wind turbine WT to e.g. facilitate an individual pitching of each blade.

In embodiments, a pitch controller PC external to the second controller C2 may be configured for complying with the same safety standards as the second controller C2. For example, the pitch controller PC may comprise redundant hardware and verifying arrangement(s) which provide a more fail safe pitch controller PC.

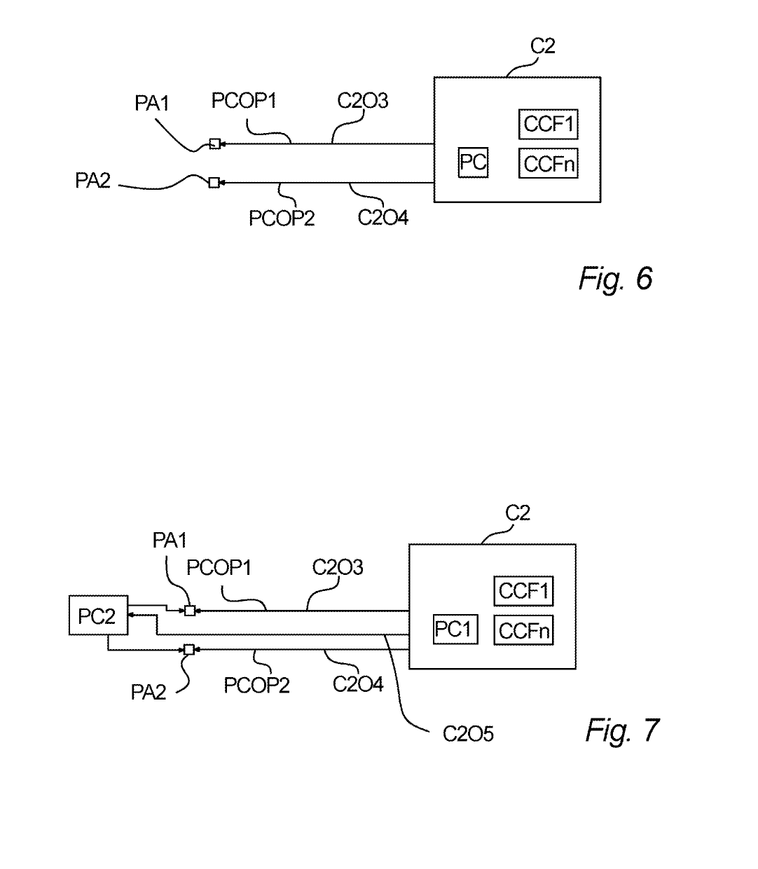

In the embodiment which is illustrated in FIG. 6, a pitch controller PC may be integrated in the second controller C2, and the second controller C2 may hence transmit pitch control signals C2O3, C2O4 to the pitch arrangements PA1, PA2 of the wind turbine WT to individually control the pitching of each blade WTB. The whole arrangement configured for controlling the blade pitching hence operates under a high degree of safety due to the implementation in the second controller C2, which operates at a higher degree of safety than the first controller C1, e.g. to redundant hardware components and/or software components as illustrated and described in relation to FIG. 4.

The embodiment of FIG. 7 relates to a pitch control which is a combination of the ones described in relation to FIGS. 5 and 6. In this embodiment, the second controller C2 comprises a pitch control facility PC1 which facilitates transmitting control signals C203, C204 to the pitching arrangements PA1, PA2 without use of a pitch controller PC2 external to the second controller C2. Additionally, the second controller C2 facilitates transmitting control signals C205 to a pitch controller PC2 external to the second controller C2 so that the pitch controller PC2 facilitates controlling the pitching means of the pitch arrangements PA1, PA2 based on the control signals from the second controller C2. In such an embodiment, the second controller C2 may control blade pitching by means of the external pitch controller PC2 during normal operation of the wind turbine WT. During emergency shutdown on the other hand, the second controller C2 may control the pitching of the blades directly by means of the pitching control facility PC1 of the second controller C2, and without using the pitch controller PC2 external to the second controller C2. So in this embodiment, the second controller C2 so to say bypasses the external pitch controller PC2 during emergency shutdown, while the second controller C2 transmit pitch control signals to the external pitch controller PC2 when the wind turbine is in normal operation to produce power.

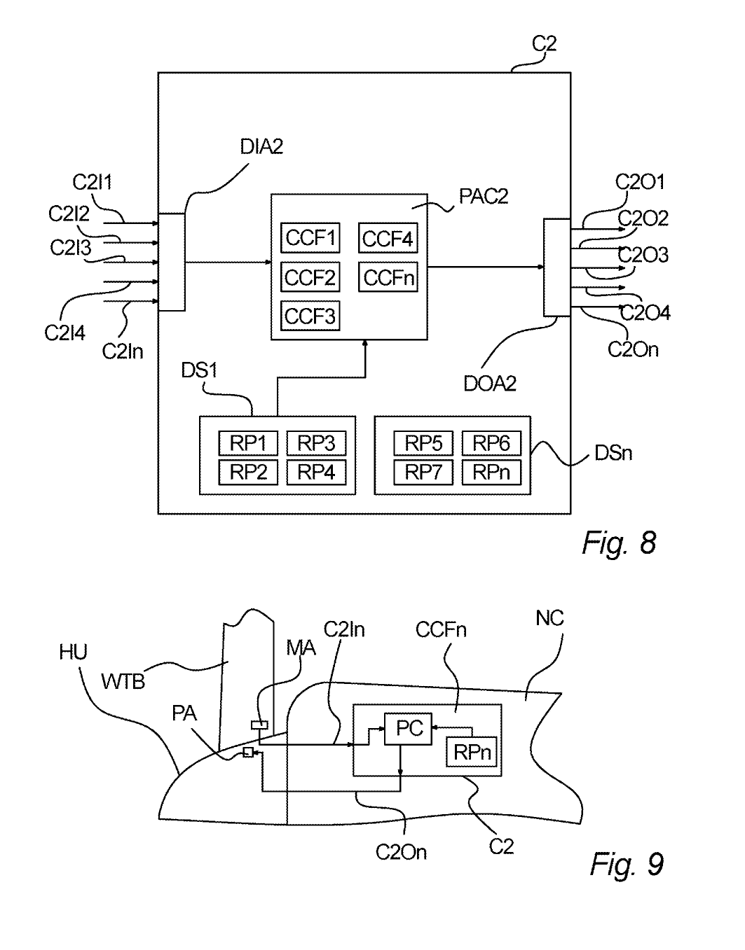

FIG. 8 illustrates an embodiment wherein a shift from normal operation into emergency shutdown mode comprises replacing the content of one or more reference parameters RP1-RPx for the critical control functions CCF1-CCFn of the second controller C2. In the embodiment of FIG. 8, the content of the reference parameters RP1-RPn are stored on a data storage DS1-DSn in the second controller C2, but it is understood that in other embodiments, the reference parameters may be stored at other locations external to the second controller C2. The reference parameters RP1-RPn are used as input to the critical control functions CCF1-CCFn of the second controller C2 together with the input parameters C2I1-C2In, and the critical control functions CCF1-CCFn utilizes the input parameters C2I1-C2In and the reference parameters RP1-RPn so as to calculate/establish the control output C2O1-C2On.

When e.g. controlling a pitch angle of one or more blades of the wind turbine, the control signal to a pitch actuator PA is a result of a processing of input parameters C2I1-C2In such as e.g. wind speed, wind direction, load measurements on the structural parts of the wind turbine WT such as main shaft torque, blade root torque, tower oscillations and/or the like. However, to properly establish a pitch reference to the pitch arrangement(s) PA, the input parameters C2I1-C2In may be considered based on reference parameters RP1-RPn. For example, if the estimated wind speed has a value of X m/s, and the tower oscillations are measured to be Y m/s², and e.g. a safety margin to be complied with is Z, where Z is one of the reference parameters RP1-RPn, the pitch angle of a blade should be D°. So the predefined reference parameters Z may together with the input X and Y be used to determine the output i.e. the pitch reference to the pitch arrangement PA. When the wind turbine WT is to be shut down according to an emergency shutdown mode, certain parameters may be neglected or amended. Hence, in embodiments, a shift from normal operation into emergency shutdown mode may comprise replacing the content of one or more reference parameters RP1-RPx. Hence if the content of the parameter RP1 is a first value of Z during normal operation then the value of the parameter RP1 i.e. Z may change in an emergency shutdown mode. So substantially the same pitch algorithm may be used but due to the shift in operation mode the reference parameters (or their values) facilitate a change in the output to the pitch arrangement.

As an example, the reference parameters RP1-RP4 of a first data storage DS1 may be utilized during normal operation of the wind turbine WT. If the second controller C2 shifts into an emergency shutdown mode, the reference parameters RP1-RP4 are replaced by the set of reference parameters RP5-RPn of a second data storage DSn, so that a set of dedicated emergency reference parameters RP5-RPn are used. The emergency reference parameters RP5-RPn may as illustrated be stored on another data storage than the reference parameters RP1-RP4 used during normal operation of the wind turbine but all reference data RP1-RPn could also be stored on one data storage. Alternatively, the value/content of the reference parameter RP1-RPx may be exchanged with another value to be used during emergency shutdown.

In preferred embodiments, the second controller C2 may be configured for applying an emergency pitch mode comprising a predetermined pitching profile during emergency shutdown. This is illustrated and described in more details in relation to FIG. 9.

The second controller C2 may be arranged to operate in accordance with a predefined first pitching profile which is utilized when the wind turbine WT is not to be shut down according to an emergency shutdown mode, and another second pitching profile used during emergency shutdown. The pitching profile(s) are configured for providing an output C2On to pitching arrangements PA (and/or a pitch control arrangement which is not illustrated in FIG. 9, see previous figs. and description) according to one or more data inputs C2In from one or more measurement arrangements MA such as sensors for measuring main shaft torque, torque acting on the tower construction, torque acting on the blade root(s), blade oscillations/vibrations, tower oscillations/vibrations and/or any other relevant measurement. The pitching of the blades WTB may hence be based on measurements to continuously pitch the blades (and/or in other ways amending their aerodynamic profile) during emergency shutdown by means of the second controller C2 to reduce e.g. tower oscillations and/or blade oscillations. The shift may comprise replacing/amending reference parameters in the algorithm(s) relevant to controlling the pitching of the blades.

In a similar way, the second controller C2 may in embodiments of the invention be configured for shifting to an emergency torque scenario configured for keeping a torque acting on a structure such as tower TW or blades WBL of the wind turbine below a certain critical level during emergency shutdown, where the second controller C2 provides a torque adjustment output determined by means of the emergency torque scenario. This is preferably also based on one or more measurements during emergency shutdown.

For example, a strain gauge or another sensor arrangement MA for measuring forces acting on a structure may be arranged to measure blade root torque on a wind turbine blade WTB. The output from this sensor may be input C2In to the second controller C2 so that the wind turbine blade WTB is continuously pitched during emergency shutdown to keep the forces acting on the blade below a predefined level, e.g. determined by a reference parameter that defines this level of maximum allowable blade root torque. The same may be applied with regard to main shaft torque, torque acting on the tower TW and/or the like.

A significantly simplified example of the use of input data and reference parameters is explained in the following. It is noted that it is only an example to illustrate the principle of the use or reference parameters and input data:

### Example 1

if ( (C2I1 > RP1) AND (C2I2 !> RP2))
{ C2O1= x [m/s]}
else if ((C2I1 < RP3) AND (C2I2 > RP4))
{ C2O1=y [m/s]}
...

In the above, C2I1 and C2I2 are data inputs from e.g. sensors and C2I1 may e.g. refer to the measured wind speed whereas C2I2 may refer to measured present tower oscillations. Now if the measured wind speed C2I1 is above a predefined value given by a reference parameter RP1, and the tower oscillations are not above a predefined value given by the reference parameter RP2, a maximum pitch speed output to one or more pitching arrangements PA (or an external pitch controller) should be x [m/s]. If these conditions are not met, but the measured wind speed C2I1 is instead below a predefined value given by a reference parameter RP3, and the tower oscillations are above a predefined value given by the reference parameter RP4, the maximum pitch speed output to one or more pitching arrangements PA (or an external pitch controller) should be y [m/s]. It is understood that the value of x [m/s] and y [m/s] may be calculated/determined based on lookup tables, one or more software algorithms and further input data as well as reference parameters and/or the like which are not illustrated and described further in this document. As indicated by the dots “ . . . ” above the example may comprise further conditions and/or the like.

Now, when entering the emergency shutdown due to a critical fault, the reference values used above may be exchanged with a new set of reference parameters, hence giving the following which describes an example of entering an emergency pitch mode:

### Example 2

if ( (C2I1 > RP5) AND (C2I2 !> RP6))
{ C2O1= x [m/s]}
else if ((C2I1 < RP7) AND (C2I2 > RPn))
{ C2O1=y [m/s]}
...

So the reference conditions may be changed and hence e.g. result in a more aggressive blade pitching than with reference parameters RP1-RP4. The algorithm(s) used may be substantially the same but may in further embodiments be amended by amending one or more further reference parameters when calculating e.g. x and y to e.g. allow a faster pitch acceleration of the blade during pitching, to amend a predefined max/min pitch speed, to amend a predefined max/min pitch angle or the like. So hence, based on exchange of reference parameters, use of data inputs, neglecting certain parts of a condition setup and/or the like, a shift from a first “normal” pitching profile to an emergency pitch mode may be facilitated.

Alternatively, two different critical control (pitching) functionalities may be implemented in the controller C2, one for normal operation and one for emergency shutdown. Hence, the first functionality may comprise a setup as e.g. the above example 1, and may be utilized during normal operation to provide power to the grid. E.g. the above example 2, may be utilized during emergency shutdown. So in such an embodiment, the second controller shifts from one critical control function to another other to pitch according to another emergency pitch functionality. So the pitching of the blades are hence controlled by different pitch applications of the wind turbine dependent on if it is in power production mode/normal operation, or in an emergency shutdown. It is noted that this in embodiments likewise may be implemented with regard to e.g. yaw control, generator control and/or the like.

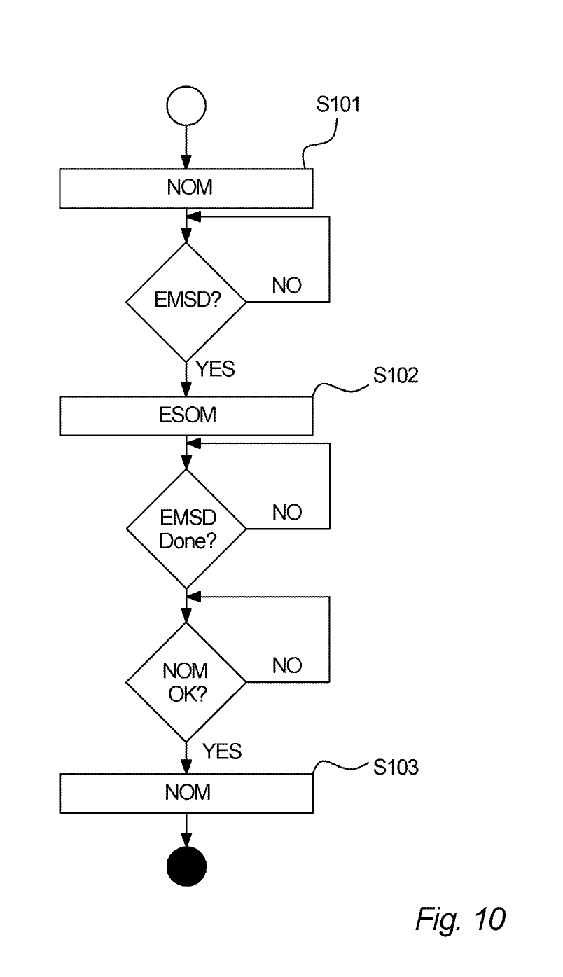

FIG. 10 illustrates an advantageous embodiment where the second controller “reset” to operate the wind turbine WT in a power production mode NOM after an emergency shutdown. The steps S101 and S102 are substantially similar to the steps S31 and S32 of FIG. 3. In the embodiment of FIG. 10 however, after step S102, it is examined weather the wind turbine WT has been shut down by the emergency shutdown (EMSD Done?). If it has, it is furthermore examined whether it is ok to start the wind turbine WT again in a power production mode (NOM OK?). If it is, the second controller C2 is shifted from the emergency shutdown mode to the normal operation mode in step S103 again. This may be achieved by introducing algorithms that were neglected in the second controller C2 during emergency shutdown, it may comprise replacement/resetting reference parameters, introducing further data inputs again, shifting from a software application for use during emergency shutdown to a software application for use during normal operation and/or the like.

In general, it is to be understood that the present invention is not limited to the particular examples described above but may be adapted in a multitude of varieties including, one or more or e.g. e.g. all figures and combinations thereof, within the scope of the invention as specified in the claims.

### REFERENCES

WT: Wind turbine
WTB: Wind turbine blade
TW: Wind turbine tower
NC: Nacelle
HU: Hub
WTCS: Wind turbine control system
C1: First controller
C2: Second controller
DIA1: Data input arrangement of first controller
DIA2: Data input arrangement of second controller
DOA1: Data output arrangement of first controller
DOA2: Data output arrangement of second controller
C2I1-C2In: Data input to second controller
C1I1-C1In: Data input to first controller
C1O1-C1On: Data output from first controller
C2O1-C2On: Data output from second controller
PA1-PAn: Data processing means
CCF1-CCFn: Critical control functionalities
CF1-CFn: Non-critical control functionalities
VA: Verifying arrangement of second controller such as e.g. a voting arrangement/voter
PAC2, PACn: Processing arrangement(s) of second controller
PAC1: Processing arrangement of first controller
MA: Measurement arrangement
YWA: Yaw arrangement of wind turbine
CS: Cooling system of wind turbine
DLA: Data logging arrangement
CON: Converter of wind turbine
DS: Data storage
RP1-RPn: Reference parameters
PA, PA1, PA2: Pitch arrangement
PC: Pitch controller
O1-On: Output from processor arrangements to voting arrangement
DI: De-icing arrangement
AL: Aviation light
CCOM: communication between first and second control unit.

What is claimed is:

1. A method of controlling a wind turbine by means of a wind turbine control system comprising a first controller and a second controller, said controlling of said wind turbine comprising handling a first set of control functionalities and a second set of control functionalities,
wherein said first set of control functionalities are non-critical control functionalities,
wherein said second set of control functionalities comprises one or more critical control functionalities which are critical for the operation of said wind turbine,
wherein said first controller handles said first set of control functionalities,
wherein said second controller is a safety controller controlling said wind turbine during emergency shutdown of said wind turbine by means of said critical control functionalities, and
wherein said second controller furthermore controls one or more of said critical control functionalities to provide an output to control said wind turbine when the wind turbine is in a power production mode.

2. A method according to claim 1, wherein said second set of control functionalities are critical to control the mechanical loads of said wind turbine.

3. A method according to claim 1, wherein said second controller operates at a higher safety level than said first controller.

4. (canceled)

5. A method according to claim 1, wherein said second controller comprises a data input arrangement receiving one or more data inputs, data processing means processing data from said one or more data inputs, and a data output arrangement providing data to one or more data outputs from said second controller based on said processing of said one or more data inputs, and
wherein said data processing means of said second controller comprises at least two processing arrangements each processing input representing the same data according to an identical set of rules, and a verifying arrangement selecting an output from at least one of said processing arrangements to form the basis for the data on output at said data output arrangement.

6. A method according to claim 1, wherein said second controller processes data from at least two data inputs which data represents the same information, and wherein the information is obtained from different data sources.

7. (canceled)

8. A method according to claim 1, wherein said second controller operates in accordance with one or more reference parameters, and wherein one or more software applications are configured for processing data inputs in accordance with said reference parameters so as to provide data output from said second controller.

9. A method according to claim 1, wherein said second controller shifts from a first operation mode to an emergency shutdown mode if said wind turbine is to be shut down due to an emergency situation.

10. (canceled)

11. A method according to claim 7, wherein said shift comprises replacing the content of one or more reference parameters and/or utilizing a set of dedicated emergency reference parameters.

12. A method according to claim 7, wherein said shift comprises shifting to an emergency pitch mode configured for pitching one or more of said wind turbine blades so as to shut down said wind turbine, and wherein said second controller provides one or more pitch outputs determined by means of said emergency pitch mode to one or more pitch arrangements of said wind turbine.

13. A method according to claim 1, wherein pitching by means of said second controller is performed according to one or more data inputs from one or more measurement arrangements during said emergency shutdown.

14. A method according to claim 7, wherein said shift comprises shifting to an emergency torque scenario for reducing a torque in said wind turbine, and wherein said second controller provides a torque adjustment output determined by means of said emergency torque scenario according to one or more data inputs from one or more measurement arrangements during said emergency shutdown.

15. (canceled)

16. A method according to claim 1, wherein said second controller comprises software code for processing input data so as to provide data outputs from said second controller, and wherein said software code is utilized for handling said critical control function during both normal operation to provide a power output, and during emergency shutdown of said wind turbine.

17. (canceled)

18. A method according to claim 1, wherein said second controller provides one or more outputs based on one or more of said one or more critical control functionalities, wherein said critical control functionalities are selected from a list consisting of:
pitching of wind turbine blades,
control of power output and/or rotation speed of the wind turbine rotor and/or generator of the wind turbine,
yaw control to rotate the nacelle,
thrust force control such as thrust force control of wind turbine tower and/or wind turbine blades, and
generator torque control.

19. (canceled)

20. A method according to claim 1, wherein at least one of said critical control functionalities handled by said second controller comprises critical monitoring functionalities wherein at least one of said monitoring functionalities is selected from a list consisting of:
thrust force monitoring,
shaft acceleration monitoring,
monitoring of tower oscillations,
monitoring of blade oscillations,
monitoring of main shaft oscillations,
rotor/generator speed monitoring,
rotor/generator acceleration monitoring,
nacelle acceleration monitoring,
pitch position tracking monitoring,
yaw misalignment to monitor that the pitch position follows a pitch reference,
pitch incoherence monitoring to monitor that the difference of the pitch position between the blades does not exceed predefined limits,
wind speed monitoring,
blade root torque monitoring,
tower torque monitoring, and
monitoring of wind speed and/or wind direction.

21. (canceled)

22. A method according to claim 14, wherein said critical monitoring functionalities are utilized for providing said one or more outputs.

23. A system for controlling a wind turbine, said system comprising a first controller and a second controller, said controlling of said wind turbine comprising handling a first set of control functionalities and a second set of control functionalities,
wherein said first set of control functionalities are non-critical control functionalities,
wherein said second set of control functionalities comprises one or more critical control functionalities which are critical for the operation of said wind turbine,
wherein said first controller is configured for handing said first set of control functionalities,
wherein said second controller is a safety controller configured for controlling said wind turbine during emergency shutdown of said wind turbine by means of said critical control functionalities, and
wherein said second controller furthermore is configured for controlling one or more of said critical control functionalities to provide an output to control said wind turbine when the wind turbine is in a power production mode.

24. A system according to claim 16, wherein said system is configured for controlling said wind turbine according to the method of claim 1.

25. A controller, for controlling a wind turbine, said controlling comprising handing one or more critical control functionalities which are critical for the operation of said wind turbine,
wherein said controller is a safety controller configured for controlling said wind turbine during emergency shutdown of said wind turbine by means of said critical control functionalities, and
wherein said second controller furthermore is configured for controlling one or more of said critical control functionalities to provide an output to control said wind turbine when the wind turbine is in a power production mode.

26. A controller according to claim 18, wherein said controller is configured for controlling said wind turbine according to the method of claim 1.

27. A wind turbine comprising a wind turbine control system according to claim 16.
